(19) United States
(12) Patent Application Publication
(10) Pub. No.: US 2026/0141635 A1
(43) Pub. Date: May 21, 2026

(54) THROUGH VIEW ON DASHBOARD

(71) Applicant: Applied Intuition, Inc., Mountain View, CA (US)

(72) Inventor: Joachim Frederik Hoekstra, Anmore BC (CA)

(21) Appl. No.: 19/347,461

(22) Filed: Oct. 1, 2025

Related U.S. Application Data
(60) Provisional application No. 63/722,321, filed on Nov. 19, 2024.

(51) Int. Cl. G06T 17/05; B60K 35/22; B60K 35/65; B60R 1/12; B60R 1/27; G06F 3/01

(52) U.S. Cl. CPC G06T 17/05; B60K 35/22; B60K 35/654; B60R 1/12; B60R 1/27; G06F 3/012; G06F 3/013; B60K 2360/21; B60R 2001/1253

(57) ABSTRACT

A system of the subject technology includes a number of external sensors placed on a body of a vehicle to provide first data and at least one internal sensor placed inside of the vehicle to provide second data. The system further includes a processor to process the first data and the second data to generate a through-view image including a three-dimensional (3-D) world representation from a perspective of a driver of the vehicle.

### CROSS REFERENCE TO RELATED APPLICATIONS

The present disclosure is related and claims priority under 35 USC § 119(e) to U.S. Provisional Application No. 63/722,321, entitled “THROUGH VIEW ON DASHBOARD,” filed on Nov. 19, 2024, the content of which is herein incorporated by reference, in its entirety, for all purposes.

### TECHNICAL FIELD

The present disclosure generally relates to vehicle visualization systems, and more particularly, to a through view on a dashboard of a vehicle.

### BACKGROUND

When parking or driving off-road, the hood and dashboard of a vehicle can often obscure critical details of the drivable surface. This obstruction can make it challenging for drivers to see important elements such as the exact location of a parking block or potential hazards like potholes and rocks when navigating off-road terrain. These visual obstructions can lead to difficulties in maneuvering the vehicle safely and accurately, increasing the risk of damage or accidents. For instance, when parking, not being able to see the curb or parking lines clearly can result in improper parking, and while off-road, unseen obstacles can cause significant damage to the vehicle's undercarriage or tires.

To address these issues, several solutions have been developed. One approach is to lower the hood position, which can improve the driver's line of sight over the front of the vehicle. Another solution is to provide a top-down view, often achieved through advanced camera systems that give a bird's-eye perspective of the vehicle's surroundings. Additionally, camera passthrough technology, such as the ultra-vision feature in the Hummer EV, allows drivers to see a live feed of the terrain directly in front of the vehicle. These technologies enhance the driver's ability to navigate both parking and off-road scenarios more safely and effectively by providing a clearer view of the drivable surface.

### SUMMARY

In some aspects, the subject disclosure relates to a system including a number of external sensors placed on a body of a vehicle to provide first data and at least one internal sensor placed inside of the vehicle to provide second data. The system further includes a processor to process the first data and the second data to generate a through-view image including a three-dimensional (3-D) world representation from a perspective of a driver of the vehicle.

In some other aspects, the subject disclosure relates to a method including configuring a plurality of external sensors placed on a body of a vehicle to provide first data and configuring at least one internal sensor placed inside of the vehicle to provide second data. The method further comprises generating, by a processor, a through-view image including a 3-D world representation from a perspective of a driver of the vehicle.

In yet other aspects, the subject disclosure relates to a vehicle including a number of external sensors and at least one internal sensor. The vehicle further includes a processor to collect first data from the plurality of external sensors and second data from the at least one internal sensor and process the first data and the second data to generate a through-view image including a 3-D world representation from a perspective of a driver of the vehicle. The external sensors are placed on a body of the vehicle, and the internal sensor is placed inside the vehicle.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example system architecture for implementing a dashboard with through view, according to some aspects of the subject technology.

FIG. 2 is a schematic diagram illustrating an example of a dashboard with through view, according to some aspects of the subject technology.

FIGS. 3A and 3B are schematic diagrams illustrating an example of a comparison between an existing dashboard and a through view dashboard of the subject technology.

FIG. 4 is a schematic diagram illustrating an example of an enhanced field of view (FOV) of a driver using a through view on the dashboard of the subject technology.

FIG. 5 is a schematic diagram illustrating an example of a panoramic-view dashboard within which aspects of the subject technology is implemented.

FIG. 6 is a schematic diagram illustrating an example of a vehicle with a limited FOV on which the through view on the dashboard of the subject technology can be implemented.

FIG. 7 is a flow diagram illustrating an example of a method of providing a through view on the dashboard, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

In some aspects, the subject technology is directed to a system and method for a through view on a dashboard, which generates a real-time three-dimensional (3-D) representation of the environment surrounding a vehicle, rendered from the driver's perspective and displayed on an in-vehicle screen. In some implementations, the system may use external sensors such as cameras, or may use light detection and ranging (LiDAR), or other sensors to capture environmental data, and internal sensors including eye-tracking cameras to determine the driver's head position. A processing unit reconstructs the 3-D world representation and renders it from the driver's viewpoint, creating the illusion of transparency through the vehicle body.

The subject disclosure introduces an innovative feature for vehicle dashboards, utilizing front-mounted sensors (e.g., cameras, LiDAR devices, and so on) to create a driver-matching perspective view. The disclosed technology transforms the panoramic car screen into a seamless, window-like display, enhancing the driver's visual experience by providing a more natural and intuitive view of the surroundings. By aligning the screen's perspective with that of the driver, it effectively bridges the gap between digital displays and real-world views, offering a more immersive and realistic driving experience.

The disclosed system not only improves situational awareness but also contributes to safer driving by reducing blind spots and providing a clearer view of the road ahead. The through-view dashboard can potentially integrate with other driver-assistance technologies, such as augmented reality navigation and obstacle detection, to further enhance the overall driving experience. The subject technology represents a significant step forward in automotive technology, aiming to make driving both more enjoyable and safer for everyone on the road.

The disclosed system would track the driver's head position to render a 3D scene from the driver's perspective, creating a transparent glass effect. The exact positioning of the sensor on the vehicle may vary based on vehicle geometry. The subject technology aims to enhance current display systems in vehicles, potentially offering a more immersive and accurate view of the surroundings.

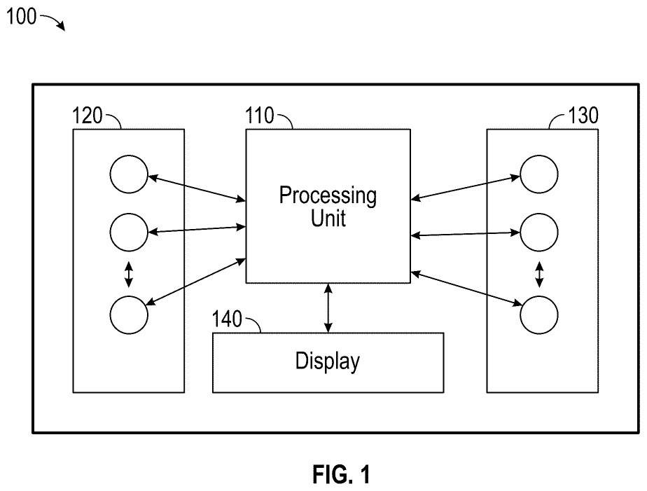

Turning now to the figures, FIG. 1 is a schematic diagram illustrating an example architecture of a system 100 for implementing a dashboard with through view, according to some aspects of the subject technology. The system 100 includes a processing unit 110 in communication with a number of external sensors 120, at least one internal sensor 130 and a display 140. The system 100 is associated with a motor vehicle, such as a car, a truck, a boat, a ship, an airplane or any other vehicle. In some aspects, the processing unit 110 can be, but is not limited to, a central-processing unit (CPU), a graphics processing unit (GPU), a cloud processor, a neural-processing unit (NPU) or any other processor.

The external sensors 120 include cameras such as video cameras, LiDARs or other sensors. At least three of the external sensors 120 are installed in three locations in front of the vehicle. Based on the dimensions and functionalities of the vehicle, additional external sensors may be installed in front, on the sides and other places on the vehicle to provide a complete set of visual data regarding the surrounding of the vehicle, as needed for the driver of the vehicle for a safe operation of the vehicle. The external sensors 120 may receive commands from the processing unit 110 and transmit data including visual data such as images and frames of video data to the processing unit 110 for processing. In some implementations, the central processing unit 110 processes visual data received from the external sensors 120 to reconstruct a 3-D representation of the world in front of (or in some cases surrounded by) the vehicle.

Examples of the internal sensors 130 include cameras, at least one of which can be placed inside the vehicle, for example, above or below or on the rear-view mirror or any other location within the vehicle that can observe the head of the driver. The inside camera can provide the location of the eyes of the driver with respect to a reference inside the vehicle to the central processing unit 110. In some implementations, the central processing unit 110 processes the data from the inside camera to estimate the driver's eye position. The central processing unit 110 uses the 3-D representation of the world and the estimate of the driver's eye position to reconstruct a 3-D world representation image from the driver's perspective. The central processing unit 110 sends the reconstructed 3-D world representation image from the driver's perspective to the display 140 in front of the driver. The display 140 can be a panoramic display, for example, a curved panoramic display.

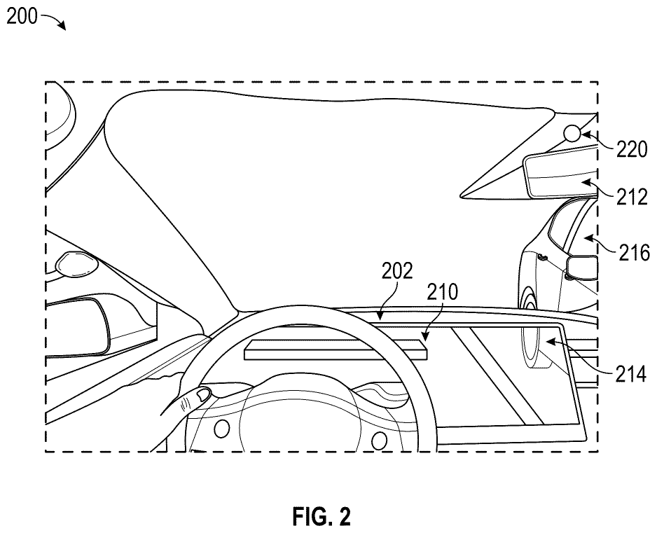

FIG. 2 is a schematic diagram illustrating an example of a dashboard 210 with through view in a vehicle 200, according to some aspects of the subject technology. FIG. 2 shows the dashboard 210 on a display 202. FIG. 2 also shows a rear-view mirror 212 and a camera 220. The through view shown in the display 202 is related to a parking scenario that illustrates the disclosed solution capabilities by allowing the driver to see through the vehicle, providing a clear view of road markings, other cars, and obstacles. For example, an image 214 of a portion of a side of a car 216 including a rear wheel, which is blocked by the front of the vehicle 200 from normal view of the driver, can be seen on the dashboard 210 with through view. The through dashboard 210 with through view can highlight potential hazards like blocks or potholes and overlay the vehicle's shape to show its boundaries. The system of the subject technology tracks the driver's head position using the camera 220 and the processing unit 110 of FIG. 1 to render the scene from the driver's perspective, making it easier to navigate and avoid obstacles.

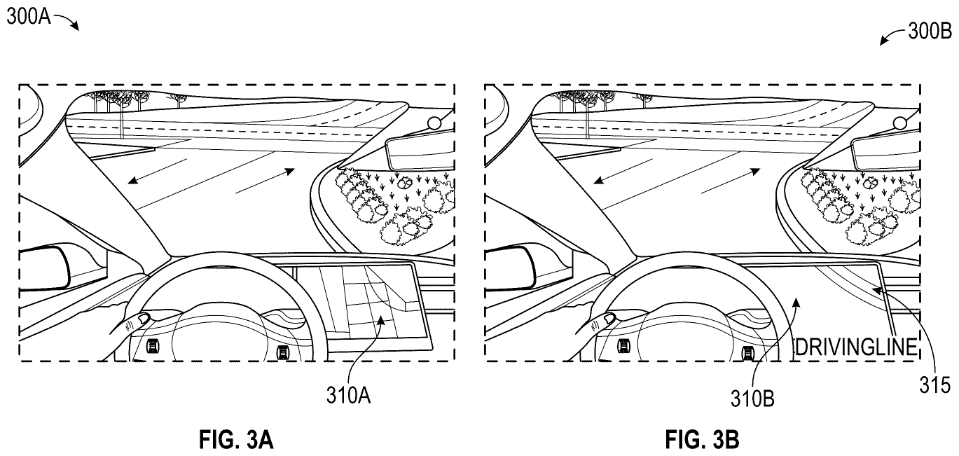

FIGS. 3A and 3B are schematic diagrams 300A and 300B, illustrating an example of a comparison between an existing dashboard 310A and a through-view dashboard 310B of the subject technology. Compared to the existing reversing cameras, the disclosed system provides a more intuitive and accurate view from the driver's perspective by allowing the driver to see the enhanced view on a large (e.g., panoramic) screen 315 that can span the dashboards. Other example situations include mining, where large obstructions may be blocking or in defense applications, where there could be lots of screens where armor may be needed. For example, the disclosed through-view dashboard 310B clearly shows part of the curb in front of the vehicle, which is absent from the existing dashboard 310A. The image shown in the through-view dashboard 310B is generated by the processing unit 110 of FIG. 1 based on 3-D world representation from a driver's perspective reconstructed based on image data from external sensors 120 of FIG. 1 (e.g., three front cameras) and the position of the eyes of the driver tracked by the inside camera 220 of FIG. 2.

In some implementations, the screen 315 can function similar to a portal, displaying a combined view from multiple cameras around the vehicle, providing additional information that the driver wouldn't normally see. The system is particularly useful for parking, as it allows the driver to see through the car and avoid obstacles. Wide-angle such as fisheye cameras or other wide-angle cameras at the front and sides of the car would be used to capture the necessary views.

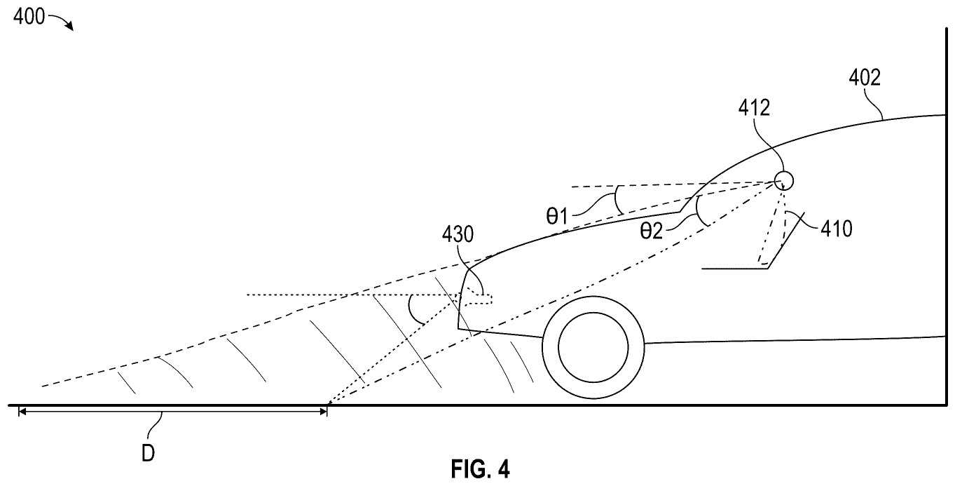

FIG. 4 is a schematic diagram illustrating an example of an enhanced field of view (FOV) 400 of a driver using a through view on the dashboard of the subject technology. The normal FOV of the driver is depicted by the angle θ1 that is limited by the hood of the vehicle 402. The disclosed system can use the images provided by one or more cameras 430 installed in suitable places in front of the vehicle 402 to extend the FOV of the driver 410 by an angle θ2, which results in extending the area seen by the driver, for example, within an additional distance D. Any obstacle (e.g., rocks) or potholes within the distance D, which was not visible to the driver 410, can be in the view of the driver 410 through the dashboard of the subject technology. In some embodiments, a semi-transparent render of the vehicle 402 can be superimposed onto the image seen on the dashboard to show where the vehicle ends. Furthermore, additional features such as highlighting obstacles and showcasing the vehicle's extent can be layered on top of the core pass-through functionality.

In some embodiments, the position of the head 412 of the driver is used to render the correct perspective on the screen. Also, the system can correct any camera distortion by building a 3-D representation of the world and rendering it from the driver's perspective. The position of the head 412 can be determined by a head tracking algorithm, which is used to create a transparent view of the vehicle. In some embodiments, the subject technology combines the head tracking and 3D rendering technologies to display a view with illusion of transparency of the vehicle from the driver's perspective.

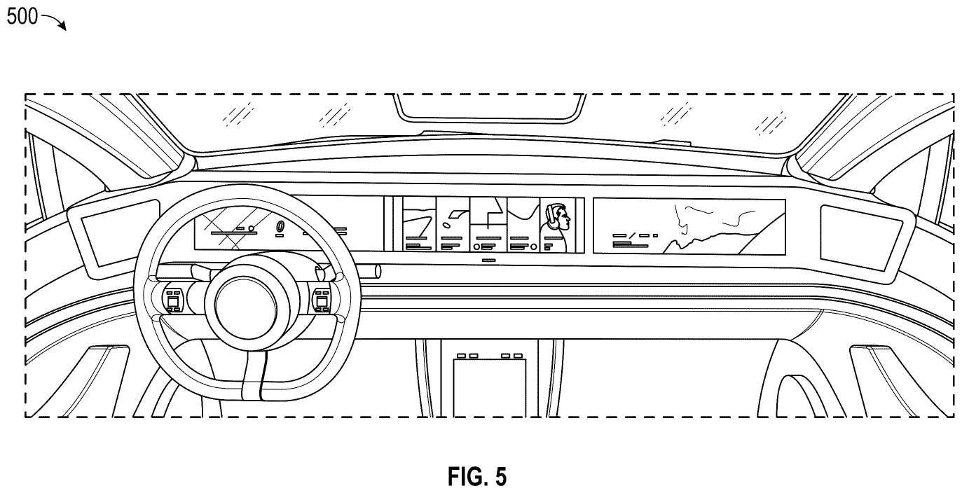

FIG. 5 is a schematic diagram illustrating an example of a panoramic-view dashboard 500 within which aspects of the subject technology can be implemented. The processing unit 110 of FIG. 1 can use images from the external sensors 120 of FIG. 1 (e.g., cameras) placed around the vehicle and the position of the eyes of the driver to generate a 3-D world representation from the perspective of the driver's eyes. Such a 3-D world representation, when displayed on the screen of the panoramic-view dashboard 500, would result in extending the driver's FOV, allowing the driver to see areas that are normally obscured.

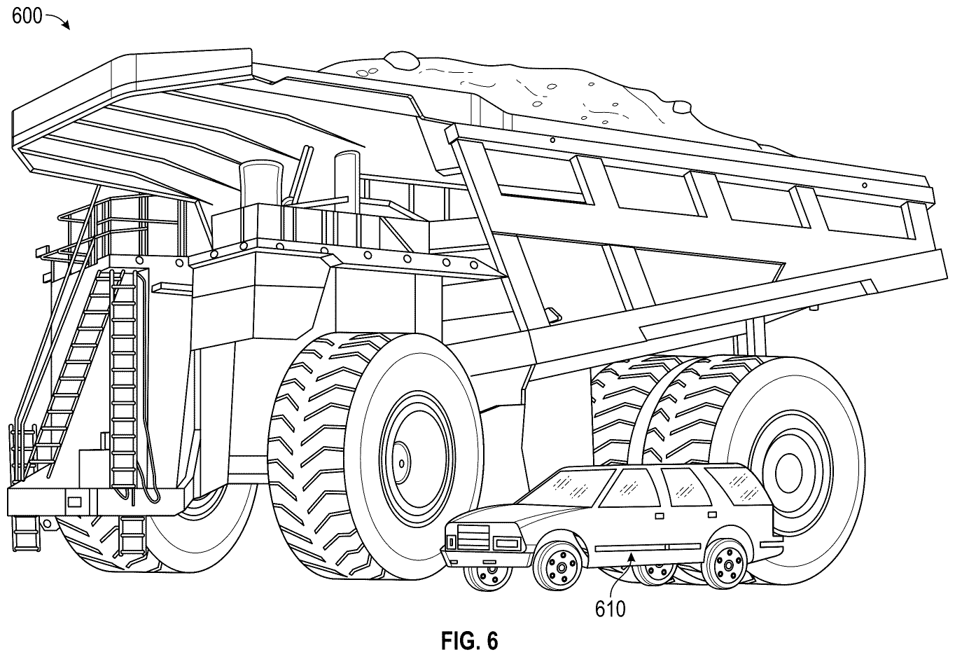

FIG. 6 is a schematic diagram illustrating an example of a vehicle 600 with a limited FOV on which the through view on the dashboard of the subject technology can be implemented. In many existing large vehicles such as the construction vehicle shown in FIG. 6, the drivers have a limited view of the front and surrounding of the vehicle. The through view on a dashboard of the subject technology can provide extended views from the front, rear and surroundings of the vehicle by using images from cameras installed in suitable places on the vehicle and combining 3D rendering and eye-tracking technologies, as described above. For example, in a normal view, the driver of the construction vehicle would not be able to see the car 610. However, the through view on the dashboard of the subject technology allows the driver to see an image of the car 610 on a display placed in its dashboard.

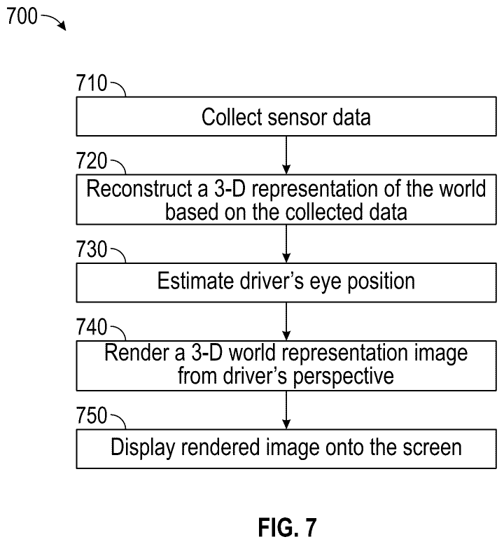

FIG. 7 is a flow diagram illustrating an example of a method 700 of providing a through view on the dashboard, according to some aspects of the subject technology. The method 700 includes steps 710, 720, 730, 740 and 750.

In step 710, sensor data from external sensors (e.g., 120 of FIG. 1) and internal sensors (e.g., 130 of FIG. 1) are collected by a processing unit (e.g., 110 of FIG. 1).

In step 720, the processing unit reconstructs a 3-D representation of the world based on the collected data in step 710. In some implementations, the reconstructing the 3-D representation can be performed by using a 3-D reconstruction algorithm such as the neural radiance field (NeRF), 3D Gaussian splatting (3DGS), depth-map projection and/or other 3-D reconstruction algorithms.

In step 730, the processing unit estimates the driver's eye position using data from an internal sensor and one or more eye-tracking algorithms. In some implementations, this can be done using a 3-D rendering engine or a 3-D rendering application programming interface (API).

In step 740, the processing unit renders a 3-D world representation image from the driver's perspective by suitably combining the 3-D representation of the world reconstructed in step 720 and the estimated driver's eye position from step 730.

In step 750, the processing unit displays the rendered image onto the screen of a dashboard of the vehicle.

An aspect of the subject technology is directed to a system including a number of external sensors placed on a body of a vehicle to provide first data and at least one internal sensor placed inside of the vehicle to provide second data. The system further includes a processor to process the first data and the second data to generate a through-view image including a three-dimensional (3-D) world representation from a perspective of a driver of the vehicle.

In some implementations, the system further includes a screen on a dashboard of the vehicle to display the through-view image to the driver of the vehicle.

In one or more implementations, the external sensors include at least three sensors placed in front of the vehicle.

In some implementations, the external sensors include cameras and LiDAR devices.

In one or more implementations, the internal sensor comprises a camera placed near or on a rearview mirror of the vehicle to provide the second data including a head position data of the driver of the vehicle.

In some implementations, the first data comprises image data or video data showing the surroundings of the vehicle including objects in front of the vehicle.

In one or more implementations, the processor generates a 3-D representation based on the first data.

In some implementations, the processor generates the through-view image by combining the 3-D representation with an estimate of a head position of the driver of the vehicle.

In one or more implementations, the processor uses an eye-tracking algorithm to estimate the head position of the driver of the vehicle.

In some implementations, a vehicle comprises a car, a truck, a boat, a ship or an airplane.

In one or more implementations, the through-view image is used to extend an FOV and a distance in front of the vehicle seen by the driver of the vehicle and provide a more immersive and accurate view of the surroundings.

Another aspect of the subject technology is directed to a method including configuring a plurality of external sensors placed on a body of a vehicle to provide first data and configuring at least one internal sensor placed inside of the vehicle to provide second data. The method further comprises generating, by a processor, a through-view image including a 3-D world representation from a perspective of a driver of the vehicle.

In some implementations, the method further includes displaying the through-view image to the driver of the vehicle through a screen of a dashboard of the vehicle.

In one or more implementations, the method further includes collecting the first data and reconstructing a 3-D representation based on the collected first data.

In some implementations, the method further includes collecting the second data and estimating a head position of the driver of the vehicle based on the collected second data.

In one or more implementations, the method further includes generating the through-view image by combining the 3-D representation with the estimated head position of the driver of the vehicle.

In some implementations, estimating the head position of the driver of the vehicle based on the collected second data is performed by an eye-tracking algorithm.

Yet another aspect of the subject technology is directed to a vehicle including a number of external sensors and at least one internal sensor. The vehicle further includes a processor to collect first data from the plurality of external sensors and second data from the at least one internal sensor and process the first data and the second data to generate a through-view image including a 3-D world representation from a perspective of a driver of the vehicle. The external sensors are placed on a body of the vehicle, and the internal sensor is placed inside the vehicle.

In one or more implementations, estimating the head position of the driver of the vehicle based on the collected second data is performed by an eye-tracking algorithm.

In some implementations, the internal sensor is a camera placed near or on a rear-view mirror of the vehicle to provide the second data including a head position data of the driver of the vehicle and the processor is configured to generate a 3-D representation based on the first data, use an eye-tracking algorithm to estimate a head position of the driver of the vehicle, and generate the through-view image by combining the 3-D representation with the estimated head position of the driver of the vehicle.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system, comprising:
a plurality of external sensors placed on a body of a vehicle and configured to provide first data;
at least one internal sensor placed inside of the vehicle and configured to provide second data; and
a processor configured to process the first data and the second data to generate a through-view image including a three-dimensional (3-D) world representation from a perspective of a driver of the vehicle.

2. The system of claim 1, further comprising a screen on a dashboard of the vehicle to display the through-view image to the driver of the vehicle.

3. The system of claim 2, wherein the external sensors include at least two sensors placed in front of the vehicle.

4. The system of claim 1, wherein the external sensors comprise cameras or light detection and ranging (LiDAR) devices.

5. The system of claim 1, wherein the at least one internal sensor comprises a camera placed near or on a rear-view mirror of the vehicle to provide the second data including a head position data of the driver of the vehicle.

6. The system of claim 1, wherein the first data comprises image data or video data showing surroundings of the vehicle including objects in front of the vehicle.

7. The system of claim 1, wherein the processor is configured to generate a 3-D representation based on the first data.

8. The system of claim 7, wherein the processor is configured to generate the through-view image by using the 3-D representation or by combining the 3-D representation with an estimate of a head position of the driver of the vehicle.

9. The system of claim 8, wherein the processor is configured to use an eye-tracking algorithm to estimate the head position of the driver of the vehicle.

10. The system of claim 1, wherein the vehicle comprises a car, a truck, a boat, a ship or an airplane.

11. The system of claim 1, wherein the through-view image is configured to extend a field-of-view (FOV) and a distance in front of the vehicle seen by the driver of the vehicle and provide a more immersive and accurate view of the surroundings.

12. A method, comprising:
configuring a plurality of external sensors placed on a body of a vehicle to provide first data;
configuring at least one internal sensor placed inside of the vehicle to provide second data; and
generating, by a processor, a through-view image including a 3-D world representation from a perspective of a driver of the vehicle.

13. The method of claim 12, further comprising displaying the through-view image to the driver of the vehicle through a screen of a dashboard of the vehicle.

14. The method of claim 12, further comprising collecting the first data and reconstructing a 3-D representation based on the collected first data.

15. The method of claim 14, further comprising collecting the second data and estimating a head position of the driver of the vehicle based on the collected second data.

16. The method of claim 15, further comprising generating the through-view image by combining the 3-D representation with the estimated head position of the driver of the vehicle.

17. The method of claim 15, wherein estimating the head position of the driver of the vehicle based on the collected second data is performed by an eye-tracking algorithm.

18. A vehicle, comprising:
a plurality of external sensors;
at least one internal sensor;
a processor configured to:
collect first data from the plurality of external sensors and second data from the at least one internal sensor; and
process the first data and the second data to generate a through-view image including a 3-D world representation from a perspective of a driver of the vehicle,
wherein,
the plurality of external sensors are placed on a body of the vehicle, and
the at least one internal sensor is placed inside the vehicle.

19. The vehicle of claim 18, wherein:
the vehicle further comprises a screen on a dashboard of the vehicle to display the through-view image to the driver of the vehicle,
the plurality of external sensors comprise cameras and LiDAR devices, and
the at least one internal sensor comprises a camera placed near or on a rear-view mirror of the vehicle to provide the second data including a head position data of the driver of the vehicle.

20. The vehicle of claim 18, wherein:
the at least one internal sensor comprises a camera placed near or on a rear-view mirror of the vehicle to provide the second data including a head position data of the driver of the vehicle and the processor is configured to:
generate a 3-D representation based on the first data;
use an eye-tracking algorithm to estimate a head position of the driver of the vehicle; and
generate the through-view image by combining the 3-D representation with the estimated head position of the driver of the vehicle.
